(19) United States
(12) Patent Application Publication
(10) Pub. No.: US 2015/0023014 A1
(43) Pub. Date: Jan. 22, 2015

(54) LAMP AND LIGHTING APPARATUS

(71) Applicant: Panasonic Corporation, Kadoma-shi, Osaka (JP)

(72) Inventor: Minako Akai, Kyoto (JP)

(73) Assignee: PANASONIC CORPORATION, Osaka (JP)

(21) Appl. No.: 13/879,695

(22) PCT Filed: Nov. 8, 2012
(86) PCT No.: PCT/JP2012/007157

§ 371 Date: Apr. 16, 2013

(30) Foreign Application Priority Data
Feb. 16, 2012 (JP) 2012-031332

(51) Int. Cl. F21K 99/00; F21V 7/04

(52) U.S. Cl. CPC F21K 9/50; F21V 7/04; F21K 9/135; F21Y 2101/02
USPC 362/235

(57) ABSTRACT

A lamp includes a base configured by a case and a heat discharging board, a supporting member disposed upright on the base, a light-transmitting substrate mounted on the supporting member, and light-emitting units mounted on the light-transmitting substrate. The supporting member includes a stand part, a rod-shaped leg part disposed upright thereon, and a head part positioned on top of the leg part. The head part has an upper surface and a side surface which is a continuation thereof. In planar view in a downwards direction, the light emitting units are positioned on a section of the light-transmitting substrate that extends beyond the upper surface. The side surface includes an inclined face that is light reflective and inclined relative to the upper surface, forming an obtuse dihedral angle therebetween.

### INVENTION FIELD

The present invention relates to a lamp and a lighting apparatus which use a light-emitting element, such as an LED (Light Emitting Diode), as a light source and in particular, the present invention relates to an art of improving light extraction efficiency.

### BACKGROUND ART

In recent years, lamps that use LEDs, which are a type of semiconductor light-emitting element, as a light source (referred to below as LED lamps), have been proposed as alternative bulb-type lamps to incandescent light bulbs (refer to Patent Literature 1 and 2).

In one example of configuration of an LED lamp, the LED lamp comprises a base, a supporting member disposed upright on the base, a light-transmitting substrate mounted on the supporting member, a light-emitting unit mounted on the light-transmitting substrate and including a plurality of LEDs, and a globe formed from a transparent material (refer to page 12 of Non-Patent Literature 1).

### CITATION LIST

### Patent Literature

[Patent Literature 1] Japanese Patent Application No. 2006-313717
[Patent Literature 2] Japanese Patent Application No. 2010-003580

### Non-Patent Literature

[Non-Patent Literature 1] Lamp Comprehensive Catalog 2010; Panasonic Corporation Lighting Company

### SUMMARY OF INVENTION

### Technical Problem

In order to improve energy efficiency of a lamp there is demand to improve light output of the lamp without increasing power supply thereto. The above can be achieved by improving light extraction efficiency, which refers to efficiency of light output for a constant power supply.

The main cause of reduced light extraction efficiency is light being emitted from the light-emitting unit towards the base. If the base is formed from a material having low light reflectivity, such as a resin or a metal not having reflectivity close to 100%, then light emitted towards the base is absorbed thereby. The above causes reduction in the light extraction efficiency of the lamp.

The present invention aims to provide a lamp with improved light extraction efficiency.

### Solution to Problem

In order to achieve the above aim, a lamp relating to the present invention comprises a base; a supporting member including a leg part that is rod-shaped and disposed upright on the base, and a head part that is positioned on top of the leg part and that has an upper surface and a side surface that is a continuation of the upper surface; a light-transmitting substrate mounted on the upper surface of the head part; and at least one light-emitting unit mounted on the light-transmitting substrate, wherein in planar view of the lamp in a downwards direction, the light-emitting unit is positioned at least partially on a section of the light-transmitting substrate that extends beyond the upper surface of the head part, at least one section of the side surface of the head part is an inclined section that is inclined relative to the upper surface of the head part and that forms an obtuse dihedral angle therebetween, and the inclined section of the side surface of the head part is light reflective.

### Advantageous Effects of Invention

In the lamp relating to the present invention described above, for light emitted from the light-emitting unit towards the side surface of the head part, an angle of incidence on the inclined section of the side surface is smaller than an angle of incidence on a non-inclined section which is perpendicular to the upper surface of the head part. As a consequence of the above, an angle of reflection of light incident on the inclined section of the side surface of the head part is smaller than an angle of reflection of light incident on the non-inclined section of the side surface, and thus an amount of light directed towards the base is reduced.

Through the above, the present invention provides a lamp with improved light extraction efficiency.

### BRIEF DESCRIPTION OF DRAWINGS

FIG. 1 is a partially cut-away perspective diagram showing structure of an LED lamp 100 relating to a first embodiment.

FIG. 2 is a cross-sectional diagram of the LED lamp 100 along line A-A′ shown in FIG. 1.

FIG. 3 is a cross-sectional diagram of the LED lamp 100 along line B-B′ shown in FIG. 1.

FIG. 4A is a schematic diagram for explaining a light pathway in an LED lamp relating to a comparative example, and FIG. 4B is a schematic diagram for explaining a light pathway in the LED lamp 100.

FIG. 5A shows an inclination angle α varied in a simulation of the LED lamp 100, FIG. 5B is a table showing a module luminous flux for varying inclination angle α, and FIG. 5C is a graph showing a relative module luminous flux for varying inclination angle α.

FIGS. 6A-6D are perspective diagrams showing general configuration of modified examples of a supporting member of the LED lamp 100, FIG. 6A showing a modified example where an upper surface and lower surface of a head part of the supporting member are square in planar view, FIG. 6B showing a modified example where the upper surface and lower surface of the head part are circular in planar view, FIG. 6C showing a modified example where the upper surface and lower surface of the head part are rectangular in planar view, and FIG. 6D showing a modified example where the upper surface and lower surface of the head part are elliptical in planar view.

FIG. 7 is a partially cut-away perspective diagram showing structure of an LED lamp 200 relating to a second embodiment.

FIG. 8 is a cross-sectional diagram of the LED lamp 200 along line A-A′ shown in FIG. 7.

FIG. 9 is a cross-sectional diagram of the LED lamp 200 along line B-B′ shown in FIG. 7.

FIG. 10A is a schematic diagram for explaining a light pathway in an LED lamp relating to a comparative example, and FIG. 10B is a schematic diagram for explaining a light pathway in the LED lamp 200.

FIG. 11 is a partially cut-away perspective diagram showing structure of an LED lamp 300 relating to a modified example.

FIG. 12 is a cross-sectional diagram of the LED lamp 300 along line A-A′ shown in FIG. 11.

FIG. 13 is a cross-sectional diagram of the LED lamp 300 along line B-B′ shown in FIG. 11.

FIG. 14A is a perspective diagram showing general configuration of a modified example of a light-transmitting substrate and the supporting member of the LED lamp 100, FIG. 14B is a cross-sectional diagram of the modified example of the light-transmitting substrate and the supporting member along line A-N shown in FIG. 14A, and FIG. 14C is a cross-sectional diagram of the modified example of the light-transmitting substrate and the supporting member along line B-B′ shown in FIG. 14A.

FIG. 15A is a perspective diagram showing general configuration of a modified example of the light-transmitting substrate and the supporting member of the LED lamp 100, FIG. 15B is a cross-sectional diagram of the modified example of the light-transmitting substrate and the supporting member along line A-A′ shown in FIG. 15A, and FIG. 15C is a cross-sectional diagram of the modified example of the light-transmitting substrate and the supporting member along line B-B′ shown in FIG. 15A.

FIG. 16A is a perspective diagram showing general configuration of a modified example of the light-transmitting substrate and the supporting member of the LED lamp 100, FIG. 16B is a cross-sectional diagram of the modified example of the light-transmitting substrate and the supporting member along line A-A′ shown in FIG. 16A, and FIG. 16C is a cross-sectional diagram of the modified example of the light-transmitting substrate and the supporting member along line B-B′ shown in FIG. 16A.

FIG. 17A is a perspective diagram showing general configuration of a modified example of the light-transmitting substrate and the supporting member of the LED lamp 100, FIG. 17B is a cross-sectional diagram of the modified example of the light-transmitting substrate and the supporting member along line A-A′ shown in FIG. 17A, and FIG. 17C is a cross-sectional diagram of the modified example of the light-transmitting substrate and the supporting member along line B-B′ shown in FIG. 17A.

FIG. 18 shows an outline of a lighting apparatus 801 relating to a modified example.

### DESCRIPTION OF EMBODIMENTS

### First Embodiment

### 1. Overall Configuration

A first embodiment of the present invention is described below with reference to the drawings.

Materials and values given in the embodiments of the present invention are merely examples of preferable materials and values, and the present invention is not in any way limited by the embodiments. Also, appropriate modifications may be made so long as there is not deviation from the technical scope of present invention. Furthermore, the embodiments may be combined in any way, so long as incompatibility does not arise therebetween.

The embodiments are explained using an LED as a semiconductor light-emitting element, but for example an LD (Laser Diode) or an organic light-emitting element may alternatively be used as the semiconductor light-emitting element. Configuration elements are not necessarily illustrated on the same scale in the drawings. Ranges provided herein include the end value at each end of the range.

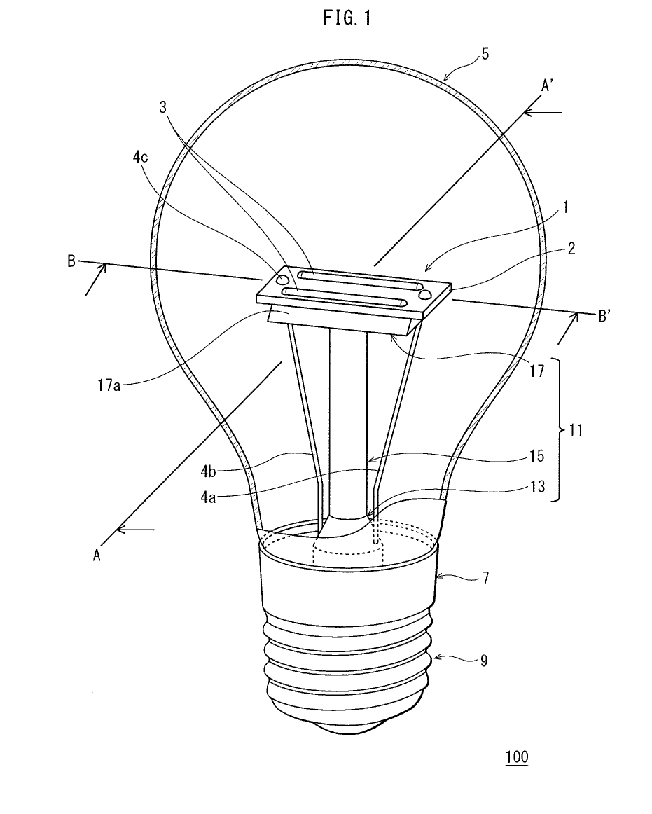

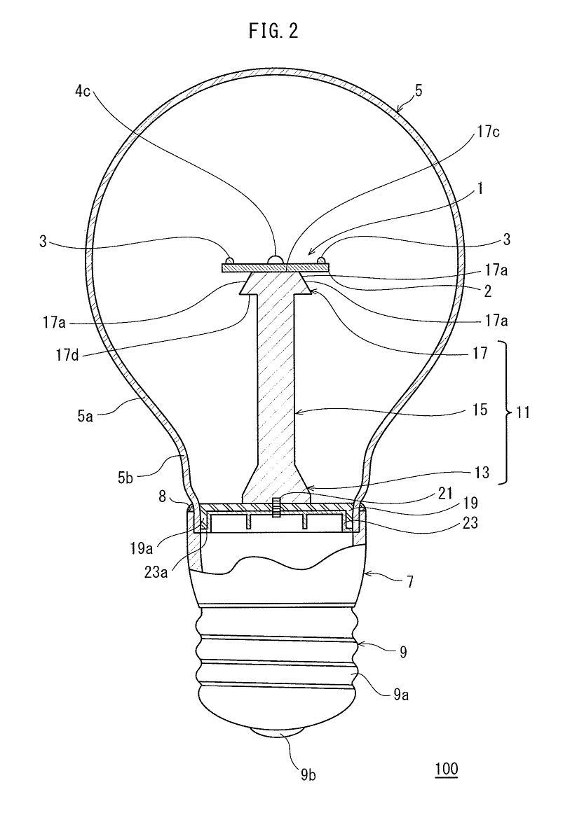

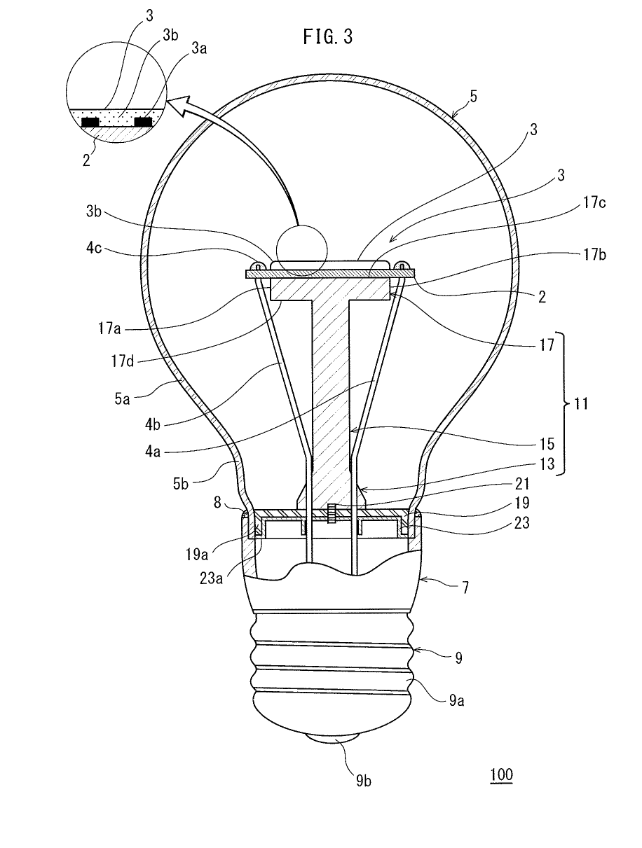

FIG. 1 is a partially cut-away perspective diagram showing structure of an LED lamp 100 relating to the first embodiment. FIG. 2 is a cross-sectional diagram of the LED lamp 100 along line A-A′ shown in FIG. 1. FIG. 3 is a cross-sectional diagram of the LED lamp 100 along line B-B′ shown in FIG. 1. In FIGS. 1-3 an upwards direction on the sheet surface corresponds to an upwards direction of the LED lamp 100, and likewise a downwards direction on the sheet surface corresponds to a downwards direction of the LED lamp 100. Left and right directions on the sheet surface correspond to a lateral direction of the LED lamp 100. The upwards, downwards and lateral directions have the same definitions in the other drawings.

The LED lamp 100 includes a base configured by a case 7 and a heat discharging board 19, a supporting member 11 disposed upright on the base, a light-transmitting substrate 2 mounted on the supporting member 11, light-emitting units 3 mounted on the light-transmitting substrate 2, a globe 5 housing the supporting member 11, the light-transmitting substrate 2 and the light-emitting units 3, and a base cap 9 connected to the globe 5 and the case 7. The following explains configuration elements shown in FIGS. 1-3.

### 2. Configuration of Elements

### <Light-Transmitting Substrate>

The light-transmitting substrate 2 is formed from a light-transmitting material such as glass, alumina, sapphire or resin. Consequently, light is emitted from LEDs 3a not only in the upwards direction of the LED lamp 100, but also passing through the light-transmitting substrate 2 in the downwards direction of the LED lamp 100.

When the LED lamp 100 is viewed in planar view from above the light-emitting units 3, the light-transmitting substrate 2 is rectangular. Two through holes are provided in the light-transmitting substrate 2. The two through holes in the light-transmitting substrate 2 are for insertion of leads 4a and 4b, which supply power from a circuit unit (not illustrated) to the LEDs 3a. A wiring pattern is provided on the light-transmitting substrate 2 in order to electrically connect the LEDs 3a, for example in parallel or series, and also to connect to the circuit unit.

### <Light-Emitting Unit>

The LED lamp 100 includes two light-emitting units 3, which each have an elongated shape. The light-emitting units 3 are positioned parallel to one another, in terms of a longitudinal direction thereof, on the light-transmitting substrate 2. Each of the light-emitting units 3 is configured by a plurality of the LEDs 3a mounted on an upper surface of the light-transmitting substrate 2, and an encapsulating member 3b which encapsulates the LEDs 3a.

The plurality of LEDs 3a mounted on the light-transmitting substrate 2 may for example be positioned at equal intervals along a straight line in a longitudinal direction of the light-transmitting substrate 2. Number and arrangement of the LEDs 3a are determined appropriately, based for example on brightness required of the LED lamp 100. In the present embodiment, LEDs that emit blue light are used as the LEDs 3a.

The encapsulating members 3b have a function of isolating the LEDs 3a from air and moisture, and also a function of converting wavelength of light emitted from the LEDs 3a. For example, each of the encapsulating members 3b may encapsulate one row of the LEDs 3a. The encapsulating members 3b are formed from a light-transmitting material such as silicone resin, and have fluorescent particles mixed therein that convert blue light to yellow light. Through the above configuration, the light-emitting units 3 emit white light which is a mixture of blue light emitted from the LEDs 3a and the yellow light emitted due to wavelength conversion by the fluorescent particles.

The leads 4a and 4b are connected to the light-emitting units 3 by connecting one end of each of the leads 4a and 4b to a power supply terminal of the wiring pattern using solder 4c. In the LED lamp 100, light emitted from the LEDs 3a passes through the light-transmitting substrate 2, and therefore light is also emitted in the downwards direction from the light-transmitting substrate 2. Consequently, if the wiring pattern is formed from a light-transmitting material, such as ITO, blocking by the wiring pattern of light emitted in the downwards direction from the light-transmitting substrate 2 can be prevented.

### <Globe>

The globe 5 has a similar configuration to a bulb section of an incandescent light bulb, and may for example be an A-type. The globe 5 has a spherical part 5a, which is a hollow sphere, and a cylindrical part 5b, which is a hollow cylinder. An opening is formed at an end of the cylindrical part 5b furthest from the spherical part 5a (an end of the globe 5 furthest in the downwards direction). The globe 5 is formed from a light-transmitting material such as glass. Alternatively, the light-transmitting material used to form the globe 5 may be a resin or the like instead of glass.

### <Base>

As explained above, in the present embodiment the base is configured by the case 7 and the heat discharging board 19. The base functions as a stand for supporting the supporting member 11. The base is not limited to the above configuration, and may be configured differently so long as the above function is still achieved. For example, the base may alternatively be configured by a single element. In teams of shape, the base may for example be a circular disc or a cuboid.

### <Case>

The case 7 may for example be formed from a resin such as polybutylene terephthalate (PBT). The case 7 houses the circuit unit therein. The other end of each of the leads 4a and 4b is connected to the circuit unit via through holes in a stand part 13. The circuit unit receives commercial power through the base cap 9, and converts the commercial power to power for lighting of the LEDs 3a. The circuit unit is configured by a circuit board and a various electronic components mounted on the circuit board.

The case 7 has a function of discharging externally heat produced by the circuit unit housed therein during lighting. Heat is discharged from the case 7 by radiation, conduction from the case 7 to external air, and convection due to the external air.

### <Heat Discharging Board>

The heat discharging board 19 has a shape similar to a circular disc having a rim section 19a thereof projecting perpendicularly from the circular disc in the downwards direction. A through hole is provided centrally in the circular disc part of the heat discharging board 19. The supporting member 11, the heat discharging board 19, and a partitioning board 23 are fixed to one another by a screw 21 inserted into the through hole.

The heat discharging board 19 blocks the opening formed at the end of the cylindrical part 5b furthest from the spherical part 5a (the end of the globe 5 furthest in the downwards direction). A gas, for example air, is sealed in the globe 5 by blocking of the opening by the heat discharging board 19. The heat discharging board 19 functions as a heat discharging element, therefore the heat discharging board 19 should preferably be formed from a material with high thermal conductivity, such as a metal or a resin.

The globe 5, the heat discharging board 19, and the case 7 are fixed to one another by an adhesive 8. The adhesive 8 may be an inorganic adhesive, or an organic adhesive such as a resin.

### <Base Cap>

The base cap 9 is provided at an opening formed at an end of the case 7 furthest from the globe 5. An outer circumference of the end of the case 7 furthest from the globe 5 has a screw thread shape that threads into the base cap 9, thus attaching the base cap 9 to the case 7.

The base cap 9 has a function of receiving power from a socket of a lighting fixture. The base cap 9 is not limited to being of a specific type, but may for example be of an Edison type. The base cap 9 includes a shell 9a which is cylindrical and which has a screw shaped circumferential wall. The base cap 9 also includes an eyelet 9b which is attached to the shell 9a by an insulating material. The shell 9a is connected to the circuit unit by the lead 4a and the eyelet 9b is connected to the circuit unit by the lead 4b.

In the present embodiment, positioning of the light-emitting units 3 in the globe 5 corresponds to positioning of a filament in an incandescent light bulb. If the globe 5 is of an A-type corresponding to an incandescent light bulb, the light-emitting units 3 are positioned centrally in the spherical part 5a. The light-emitting units 3 are positioned centrally in the spherical part 5a based on the globe 5. The light-emitting units 3 are positioned so that a distance from a tip end of the base cap 9 (an end where the eyelet 9b is positioned) is approximately equivalent to a distance from a tip end of a base cap to the filament in the incandescent light bulb.

### <Supporting Member>

The supporting member 11 includes the stand part 13, a leg part 15 which is rod-shaped and extends in the upwards direction from the stand part 13, and a head part 17 which is provided on top of the leg part 15. The supporting member 11 extends from the heat discharging board 19 towards a central section of the globe 5.

The supporting member 11 has a function of supporting the light-transmitting substrate 2, and also a function of discharging heat during light emission by the LED lamp 100. Heat produced by the light-emitting units 3 is conducted to the heat discharging board 19 through the light-transmitting substrate 2 and the supporting member 11. The heat conducted to the heat discharging board 19 accumulates in the globe 5, and subsequently is discharged externally from the LED lamp 100 by discharge from the globe 5. Therefore, preferably the supporting member 11 should be formed from a material with high thermal conductivity, such as a metal or a resin. For example, by forming the supporting member 11 from aluminum, weight of the LED lamp 100 can be reduced.

In the present embodiment, each of the light-emitting units 3 is positioned so as to be entirely on a section of the light-transmitting substrate 2 that extends beyond an upper surface 17c of the head part 17 of the supporting member 11.

(Stand Part of the Supporting Member)

The stand part 13 has a bottom section which is a cylinder and a top section which is a tapered cylinder. Through holes are provided in the stand part 13 for insertion of the leads 4a and 4b.

(Leg Part of the Supporting Member)

The leg part 15 of the supporting member 11 extends in the upwards direction from the stand part 13. The leg part 15 of the supporting member 11 is a thin rod-shape in order to prevent blocking of light that has passed through the light-transmitting substrate 2 after emission from the LEDs 3a.

(Head Part of the Supporting Member)

The head part 17 of the supporting member 11 is a cuboid and has the upper surface 17c, a side surface which is a continuation of the upper surface 17c, and a lower surface 17d. In the present embodiment, the head part 17 has four side faces which form the side surface of the head part 17. Two of the side faces in opposing positions are inclined relative to an LED 3a mounting surface of the light-transmitting substrate 2, and the remaining two side faces are perpendicular relative to the LED 3a mounting surface of the light-transmitting substrate 2.

More specifically, two sections of the side surface of the head part 17 are inclined faces 17a which are inclined relative to the LEDs 3a mounting surface of the light-transmitting substrate 2. An obtuse dihedral angle is formed between each of the inclined faces 17a and the upper surface 17c of the head part 17 of the supporting member 11. The inclined faces 17a of the head part 17 of the supporting member 11 are parallel to a longitudinal direction of the light-emitting units 3.

If the head part 17 of the supporting member 11 is formed from a metal, the inclined faces 17a of the head part 17 are light reflecting surfaces. In the present embodiment, mirror finishing is performed on a surface of each of the inclined faces 17a of the head part 17 of the supporting member 11 in order to further increase light reflectivity of the inclined faces 17a. On the other hand, if an inner part of the head part 17 of the supporting member 11 is formed from a resin or the like, a light reflective film such as a metal film may be provided on the surface of each of the inclined faces 17a.

In contrast to the above, two side faces 17b of the head part 17 are perpendicular relative to the LED 3a mounting surface of the light-transmitting substrate 2. A right angled dihedral angle is formed between each of the side faces 17b and the upper surface 17c of the head part 17 of the supporting member 11.

The light-transmitting substrate 2 is mounted on the upper surface 17c of the head part 17 of the supporting member 11. More specifically, each of the encapsulating members 3b is fixed using adhesive on a section of the light-transmitting substrate 2 which is not joined to the head part 17 of the supporting member 11. Consequently, each of the light-emitting units 3 is positioned at least partially on the section of the light-transmitting substrate 2 which is not joined to the head part 17 of the supporting member 11.

### <Partitioning Board>

The partitioning board 23 has a shape similar to a circular disc having a rim section 23a thereof projecting perpendicularly from the circular disc in the downwards direction. A through hole is provided centrally in the partitioning board 23. An upper surface of the partitioning board 23 is fixed along a lower surface of the heat discharging board 19 using an adhesive. The partitioning board 23 is provided in order to prevent transmission of heat produced by the light-emitting units 3 to the circuit unit housed in the case 7. Therefore, preferably the partitioning board 23 should be formed from a material with low thermal conductivity, such as a resin.

### 3. Light Extraction Efficiency

### <Overview>

In the LED lamp 100 relating to the present embodiment, the light-emitting units 3 are provided at a position in the globe 5, which is approximately equivalent to a position of a light source in an incandescent light bulb. As a consequence of the above, even if the LED lamp 100 is installed in a lighting fixture, provided with a light reflective mirror, which is intended for installation of a conventional incandescent light bulb, the light-emitting units 3 are positioned at a focus position of the light reflecting mirror. The above ensures that when the LED lamp 100 is installed in the lighting fixture, light distribution characteristics are similar to when the incandescent light bulb is installed.

### <Improvement of Light Extraction Efficiency Due to Head Part Side Surface Inclination>

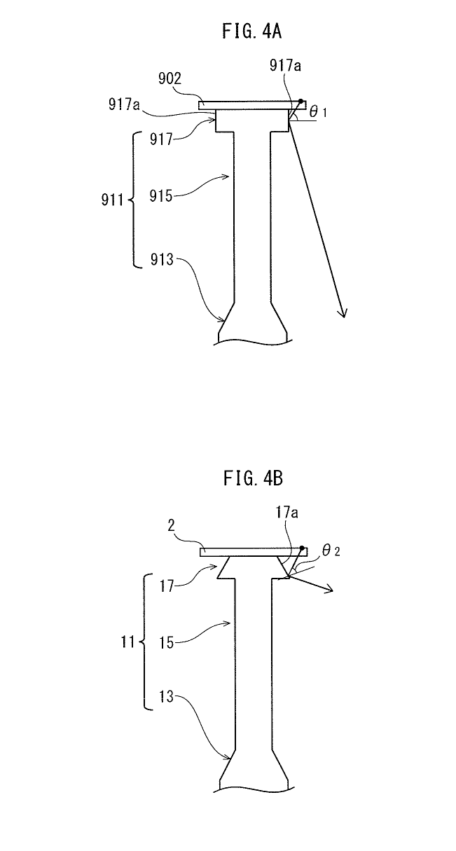

FIG. 4A is a schematic diagram for explaining a light pathway in an LED lamp relating to a comparative example, and FIG. 4B is a schematic diagram for explaining a light pathway in the LED lamp 100. The lamps shown in FIGS. 4A and 4B differ only in terms of shape of the head part of the supporting member. The light pathway in each of FIGS. 4A and 4B is explained for light emitted at the same angle from the same position in the light-transmitting substrate.

In FIG. 4A, a side face 917a of a head part 917 of a supporting member 911 is perpendicular (not inclined) relative to a light-emitting unit mounting surface of a light-transmitting substrate 902. In FIG. 4A, an angle of incidence of emitted light on the side face 917a is θ₁. The incident light is subsequently reflected by the side face 917a towards a base of the lamp. The angle of incidence on the side face 917a of the light emitted by the light-emitting unit is large, and thus an angle of reflection of the light from the side face 917a is also large.

If the base is configured by a case and a heat discharging board both with low light reflectivity, the light reflected from the side face 917a towards the case and the heat discharging board is absorbed thereby. Even if the base is configured by the case with low light reflectivity and a heat discharging board with high light reflectivity, the light reflected from the side face 917a towards the case is absorbed thereby. As described above, if light is directed towards the base of the LED lamp 100, light extraction efficiency of the LED lamp 100 is reduced.

In contrast to FIG. 4A, in FIG. 4B the inclined face 17a of the head part 17 of the supporting member 11 is inclined relative to the upper surface of the light-transmitting substrate 2. In FIG. 4B, an angle of incidence of emitted light on the inclined face 17a is θ₂. The incident light is subsequently reflected by the inclined face 17a in the lateral direction of the LED lamp 100. Due to inclination of the inclined face 17a of the head part 17 of the supporting member 11, the angle of incidence on the inclined face 17a of light emitted from the light-emitting units 3 is smaller than the angle of incidence in FIG. 4A where the side face of the head part of the supporting member is not inclined. As a result of the above, an angle of reflection from the inclined face 17a is small, and thus reflection of light from the inclined face 17a towards the base can be reduced.

### <Simulation of Head Part Inclination Angle>

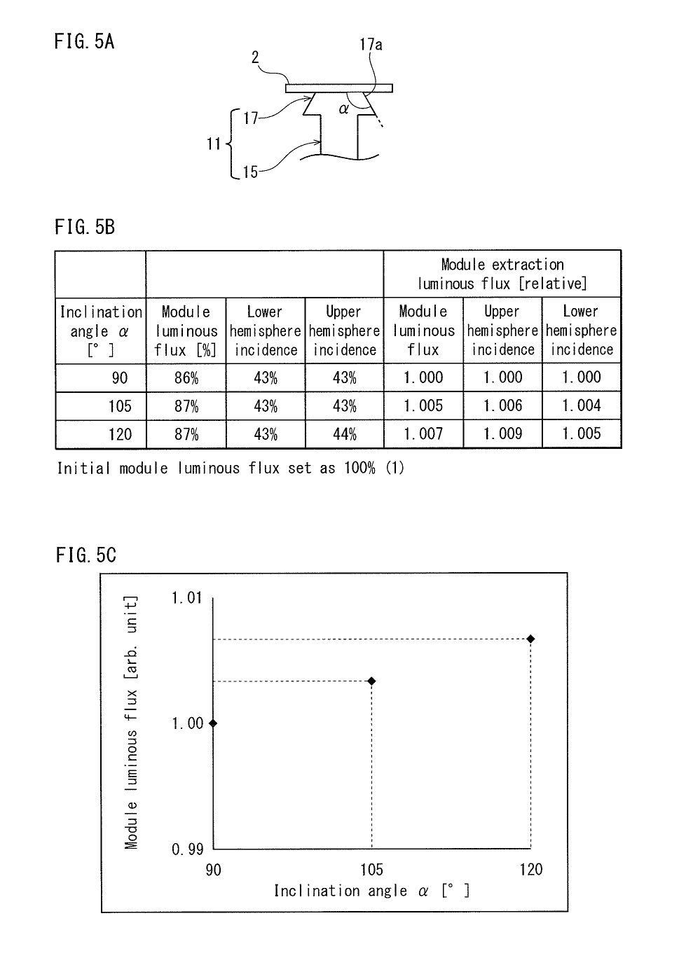

FIGS. 5A-5C are for explaining simulation results for the LED lamp 100 shown in FIG. 1. FIG. 5A shows a dihedral angle α (referred to below as inclination angle α) formed between the upper surface 17c of the head part 17 and each of the inclined faces 17a of the head part 17, which was varied in the simulation. FIG. 5B is a table showing module luminous flux for when the inclination angle α is 90°, 105° and 120°. FIG. 5C is a graph showing relative module luminous flux when the module luminous flux is set as 1.000 for when the inclination angle α is 90°. The present simulation was performed assuming that the lamp has the globe removed and in a three dimensional space. In the simulation a light source was assumed to be the whole of the light-transmitting substrate 2.

As shown in FIGS. 5B and 5C, the relative module luminous flux is 1.005 and 1.007 respectively for when the inclination angle α is 105° and 120°. In other words, the relative module luminous flux is increased compared to when the inclination angle α is 90°. The above shows that by inclination of the side surface of the head part 17 of the supporting member 11, the light extraction efficiency can be improved.

As explained above, through the configuration described in the present embodiment, the LED lamp 100 having improved light extraction efficiency can be provided.

### 4. Modified Examples of the Supporting Member

The supporting member is not limited to the structure shown in the LED lamp 100 relating to the present embodiment, and may alternatively have a different structure.

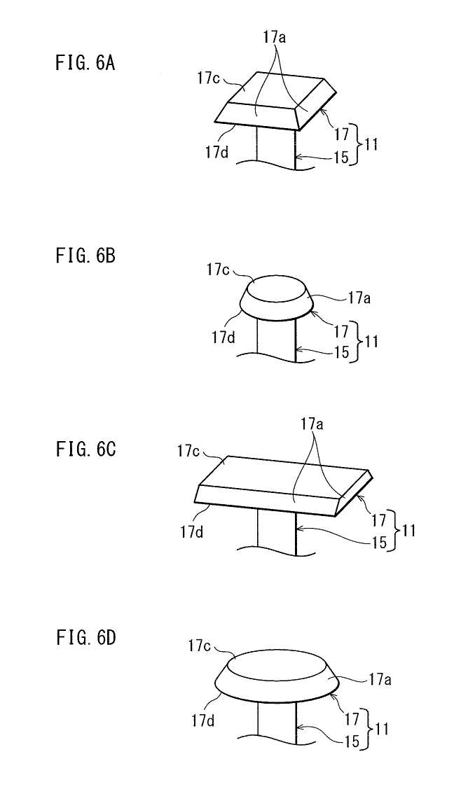

FIGS. 6A-6D are perspective diagrams showing general configuration of modified examples of the supporting member in the LED lamp 100 shown in FIG. 1.

As shown in FIG. 6A, the supporting member 11 includes the leg part 15 and the head part 17, but alternatively the upper surface 17c and the lower surface 17d of the head part 17 may be square, and the inclined faces 17a may be all four side faces of the head part 17. The present configuration may be applicable when the light-transmitting substrate 2 is also square in planar view in a longitudinal direction of the supporting member 11. In the present modified example, direction of emitted light towards the base can be reduced compared to in the first embodiment due to the inclined faces 17a of the head part 17, and thus the light extraction efficiency is further improved.

As shown in FIG. 6B, the supporting member 11 includes the leg part 15 and the head part 17, but alternatively the upper surface 17c and the lower surface 17d of the head part 17 may be circular, and the inclined face 17a may be the entire side surface of the head part 17. In the same way as in FIG. 6A, in the present configuration direction of emitted light towards the base can be reduced compared to in the first embodiment due to the inclined face 17a of the head part 17, and thus the light extraction efficiency can be further improved.

As shown in FIG. 6C, the supporting member 11 includes the leg part 15 and the head part 17, but alternatively the upper surface 17c and the lower surface 17d of the head part 17 may be rectangular, and the inclined faces 17a may be all four side faces of the head part 17. The present configuration may be applicable when the light-transmitting substrate 2 is also rectangular in planar view in the longitudinal direction of the supporting member 11.

As shown in FIG. 6D, the supporting member 11 includes the leg part 15 and the head part 17, but alternatively the upper surface 17c and the lower surface 17d of the head part 17 may be elliptical, and the inclined face 17a may be the entire side surface of the head part 17. The present configuration may be applicable when the light-transmitting substrate 2 is also elliptical in planar view in the longitudinal direction of the supporting member 11. In the same way as in FIG. 6A, in the present configuration direction of emitted light towards the base can be reduced compared to in the first embodiment due to the inclined face 17a of the head part 17, and thus the light extraction efficiency can be further improved.

### Second Embodiment

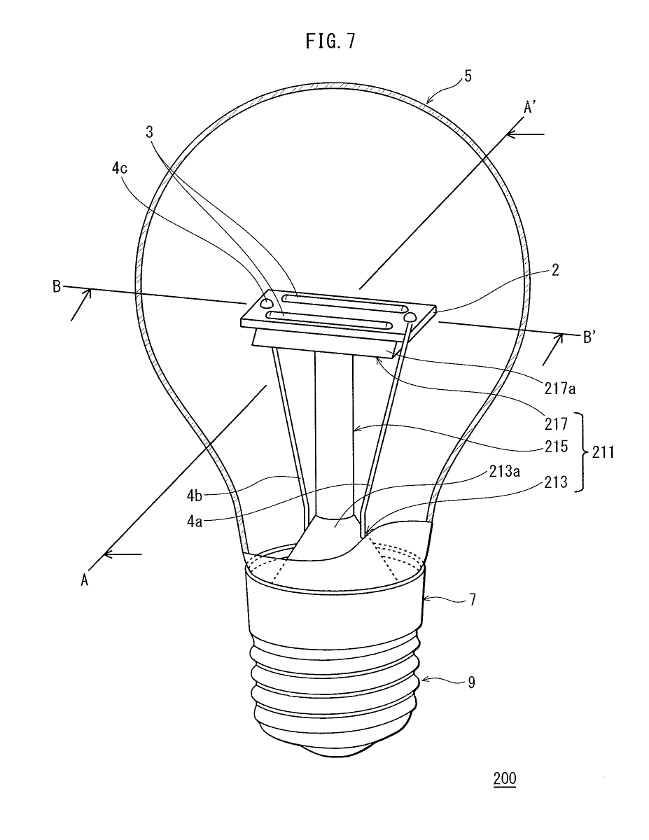

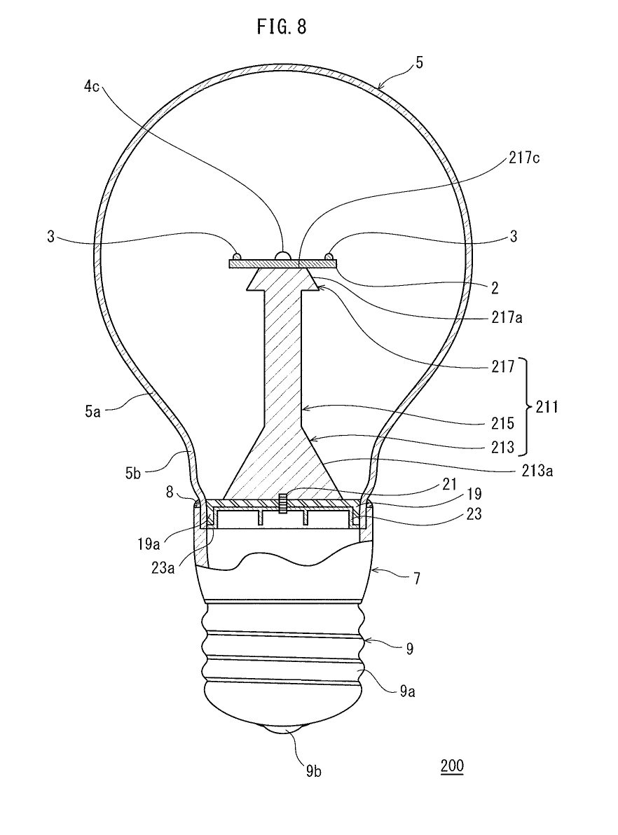

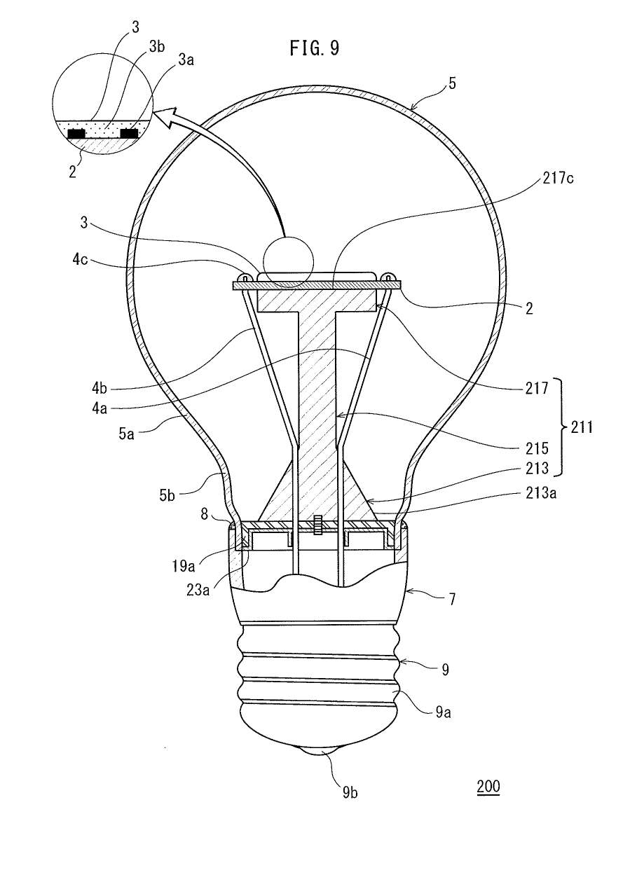

FIG. 7 is a partially cut-away perspective diagram showing structure of an LED lamp 200 relating to a second embodiment. FIG. 8 is a cross-sectional diagram of the LED lamp 200 along line A-A′ shown in FIG. 7. FIG. 9 is a cross-sectional diagram of the LED lamp 200 along line B-B′ shown in FIG. 7. The LED lamp 200 is explained below with reference to FIGS. 7-9. Configuration elements which are identical to in the first embodiment are labeled using the same reference signs in FIGS. 7-9, and explanation thereof is omitted.

The LED lamp 200 in present embodiment differs from the LED lamp 100 relating to the first embodiment in terms of configuration of the stand part.

### 1. Configuration

A stand part 213 is formed for example from a metal such as aluminum, and has a side surface that is light reflective and on which mirror finishing has been performed. Alternatively, the stand part 213 may be formed from a resin or the like instead of a metal. If the stand part 213 is formed from a resin or the like, the stand part 213 may have a side surface on which mirror finishing has been performed or a side surface on which a light reflective film has been formed using a metal film or the like.

The whole of the side surface of the stand part 213 is an inclined face 213a, which is inclined relative to the light-emitting unit 3 mounting surface of the light-transmitting substrate 2. More specifically, the inclined face 213a of the stand part 213 of a supporting member 211 is inclined relative to an upper surface 217c of a head part 217 of the supporting member 211, so that an obtuse dihedral angle is formed between the inclined face 213a and the upper surface 217c. The stand part 213 is formed starting from a position further in the upwards direction than the stand part 13 relating to the first embodiment.

### 2. Effect

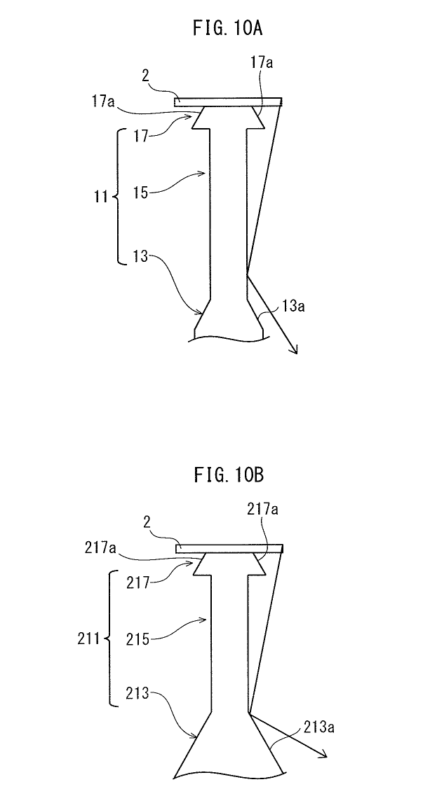

FIG. 10A is a schematic diagram for explaining a light pathway in the LED lamp 100 relating to the first embodiment, and FIG. 10B is a schematic diagram for explaining a light pathway in the LED lamp 200 shown in FIG. 7. FIGS. 10A and 10B differ only in terms of shape of the stand part. The light pathway in each of FIGS. 10A and 10B is explained for light emitted at the same angle from the same point in the light-transmitting substrate.

As shown in FIG. 10A, in the case of the stand part 13 which does not have a large tapered shape, the light is not incident on a side surface 13a of the stand part 13 and instead is incident on the leg part 15 of the supporting member 11. The incident light is subsequently reflected by the leg part 15 towards the base of the lamp. As explained above, direction of the light downwards towards the base of the lamp causes reduction of the light extraction efficiency compared to when the light is directed in the lateral direction or the upwards direction of the lamp.

In contrast to the above, as shown in FIG. 10B, in the case of the stand part 213 which has a large tapered shape, the light is incident on the inclined face 213a of the stand part 213. The incident light is subsequently reflected by the inclined face 213a of the stand part 213 in the lateral direction of the lamp. When the light is directed in the lateral direction of the lamp, the light extraction efficiency is improved compared to when the light is directed towards the base of the lamp.

As explained above, through the configuration described in the present embodiment, the LED lamp 200 having improved light extraction efficiency compared to the LED lamp 100 can be provided.

### MODIFIED EXAMPLES

Configuration of the present invention was explained based on the embodiments above, but the present invention is not limited by the embodiments. For example, the present invention may alternatively be realized as in the following modified examples.

### First Modified Example

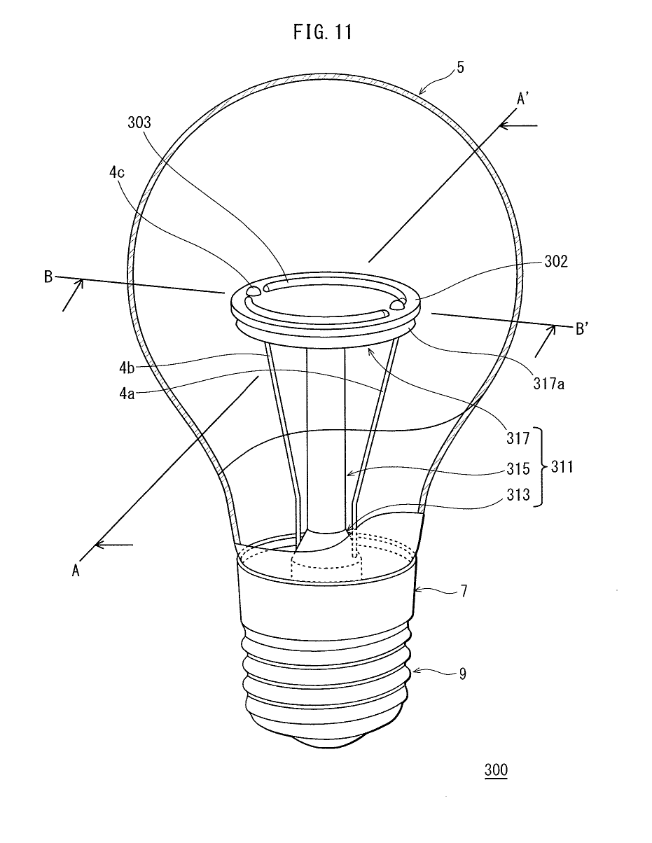

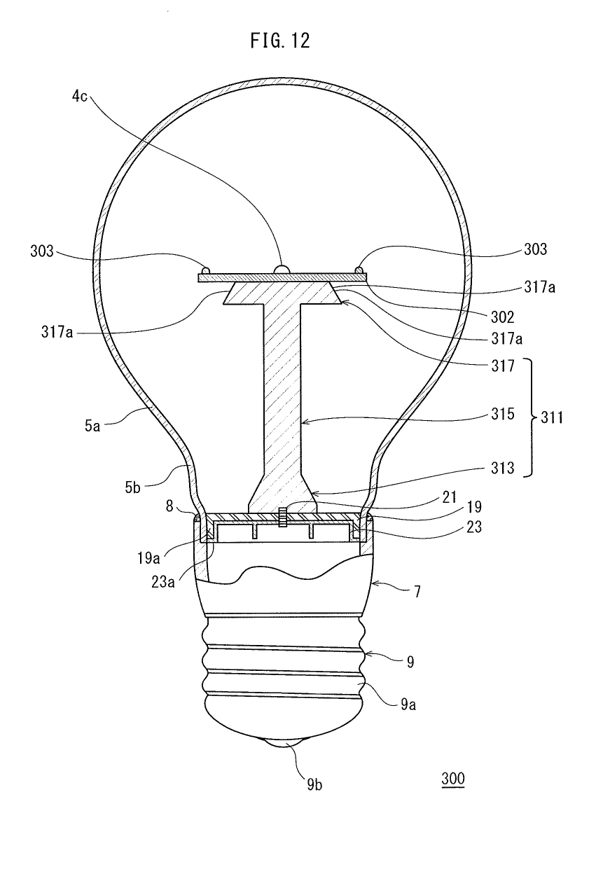

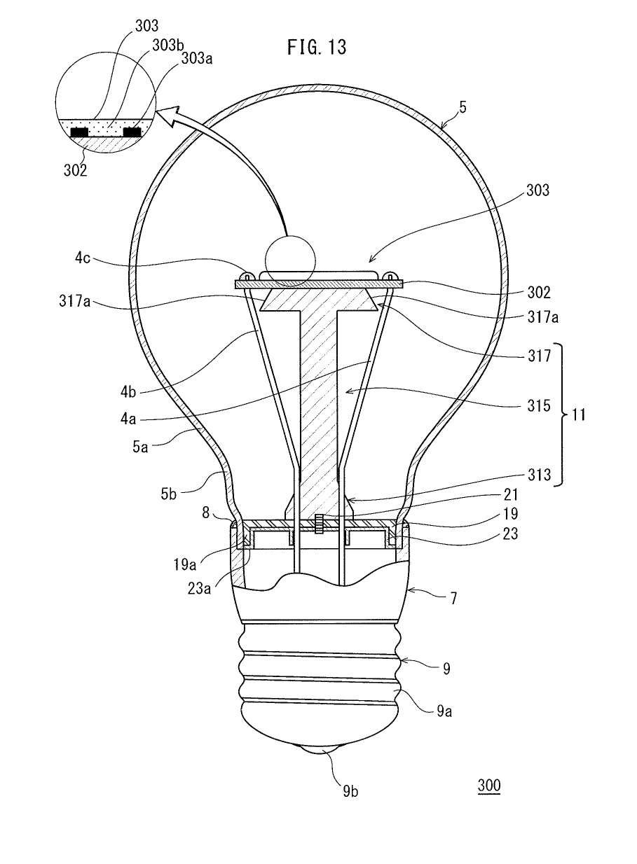

FIG. 11 is a partially cut-away perspective diagram showing structure of an LED lamp 300 relating to a first modified example of the first embodiment. FIG. 12 is a cross-sectional diagram of the LED lamp 300 along line A-A′ shown in FIG. 11. FIG. 13 is a cross-sectional diagram of the LED lamp 300 along line B-B′ shown in FIG. 11. The LED lamp 300 is explained below with reference to FIGS. 11-13. Configuration elements which are identical to in the first embodiment are labeled using the same reference signs in FIGS. 11-13, and explanation thereof is omitted.

The LED lamp 300 in present modified example differs from the LED lamp 100 relating to the first embodiment in terms of configuration of the light-transmitting substrate, the light-emitting unit, and the supporting member.

### 1. Configuration

The LED lamp 300 includes a light-transmitting substrate 302, which is a circular disc. In the present modified example, encapsulating members 303b (light-emitting units 303) are curved, thus differing from the encapsulating members 3b in the first embodiment which are straight. A supporting member 311 is configured by a stand part 313, a leg part 315 and a head part 317. The head part 317 has an upper surface and a lower surface which are circular, and a side surface, all of which is an inclined face 317a.

### 2. Effect

In the above configuration, light emitted from the light-emitting units 303 is reflected by the inclined face 317a of the head part 317, even in a situation using the light-transmitting substrate 302 which is a circular disc. Consequently, the light extraction efficiency of the LED lamp 300 can be improved.

### Second Modified Example

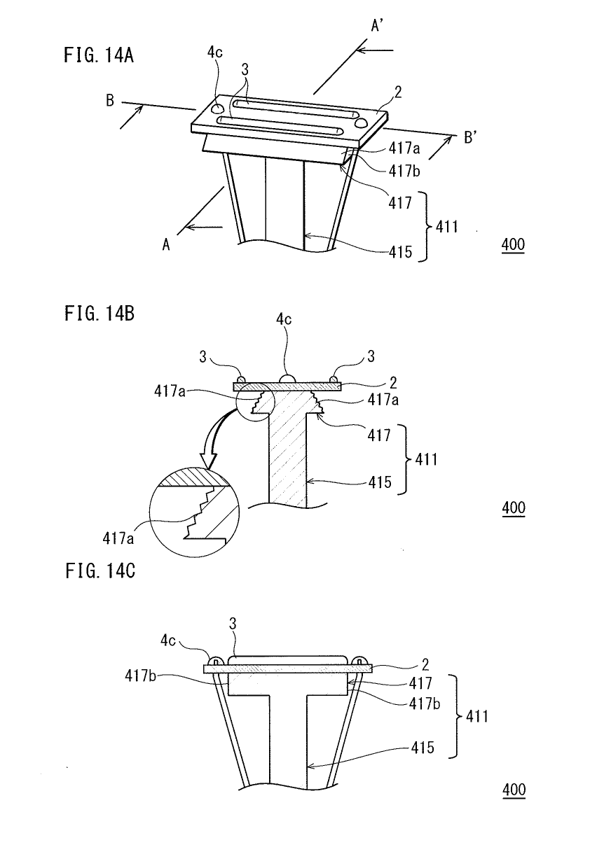

FIG. 14A is a perspective diagram showing structure of a supporting member in an LED lamp 400 relating to a second modified example of the first embodiment. FIG. 14B is a cross-sectional diagram of the supporting member in the LED lamp 400 along line A-A′ shown in FIG. 14A. FIG. 14C is a cross-sectional diagram of the supporting member in the LED lamp 400 along line B-B′ shown in FIG. 14A. Configuration elements which are identical to in the first embodiment are labeled using the same reference signs in FIGS. 14A-14C, and explanation thereof is omitted.

The LED lamp 400 in present modified example differs from the LED lamp 100 relating to the first embodiment in terms of configuration of the inclined face of the head part of the supporting member.

### 1. Configuration

The LED lamp 400 includes a supporting member 411 having a leg part 413 and a head part 417 in the same way as the supporting member 11 in the LED lamp 100. The head part 417 of the supporting member 411 has four side faces which form a side surface of the head part 417. Two of the side faces are inclined faces 417a, and the remaining two side faces are non-inclined faces 417b. The inclined faces 417a of the head part 417 are inclined relative to the light-emitting unit 3 mounting surface of the light-transmitting substrate 2. The inclined faces 417a are two of the side faces which are parallel to the longitudinal direction of the light-emitting units 3. In the LED lamp 400, surface roughness of the inclined faces 417a of the head part 417 is greater than surface roughness of the non-inclined faces 417b of the head part 417.

### 2. Effect

In the above configuration, surface roughness of the inclined faces 417a of the head part 417 being high causes improved light-scattering of light emitted from the light-emitting units 3 which is incident on the inclined faces 417a. The improved light-scattering causes improvement of a light distribution characteristic of the LED lamp 400.

### Third Modified Example

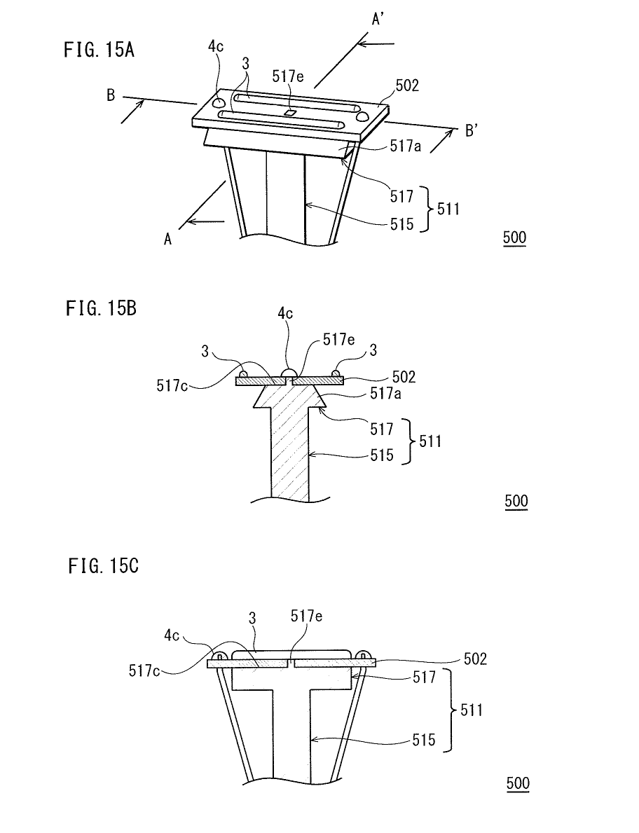

FIG. 15A is a perspective diagram showing structure of a supporting member in an LED lamp 500 relating to a third modified example of the first embodiment. FIG. 15B is a cross-sectional diagram of the supporting member in the LED lamp 500 along line A-A′ shown in FIG. 15A. FIG. 15C is a cross-sectional diagram of the supporting member in the LED lamp 500 along line B-B′ shown in FIG. 15A. Configuration elements which are identical to in the first embodiment are labeled using the same reference signs in FIGS. 15A-15C, and explanation thereof is omitted.

The LED lamp 500 in present modified example differs from the LED lamp 100 in the first embodiment in terms of configuration of the light-transmitting substrate and the supporting member, and also in terms of method of fixing the light-transmitting substrate to the supporting member.

### 1. Configuration

The LED lamp 500 includes a light-transmitting substrate 502 having a through hole provided approximately centrally therein. A head part 517 of a supporting member 511 has a protrusion 517e provided thereon. The light-transmitting substrate 502 is joined to an upper surface 517c of the head part 517 of the supporting member 511 using an engagement structure. In other words, the through hole in the light-transmitting substrate 502 corresponds to the protrusion 517e of the supporting member 511 in terms of shape, and the protrusion 517e is inserted (fitted) into the through hole. Once the protrusion 517e is inserted into the through hole, adhesive is applied therebetween, thus fixing the light-transmitting substrate 502 to the supporting member 511.

### 2. Effect

In the above configuration the light-transmitting substrate 502 is fixed to the supporting member 511 using the through hole provided in the light-transmitting substrate 502 and the protrusion 517e provided on the head part 517 of the supporting member 511. An effect of the above configuration is that the light-transmitting substrate 502 is fixed to the supporting member 511 more securely than in a configuration where only adhesive is used.

### Fourth Modified Example

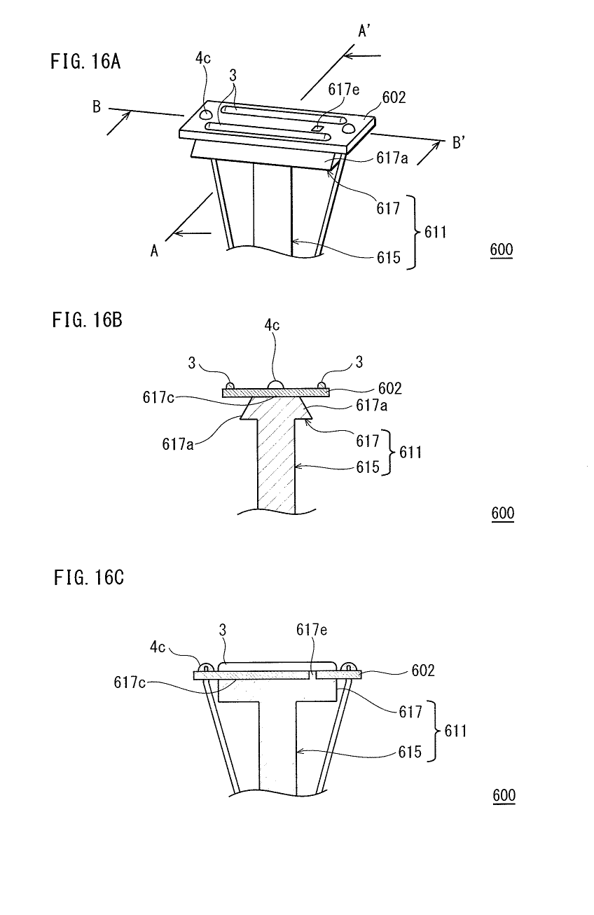

FIG. 16A is a perspective diagram showing structure of a supporting member in an LED lamp 600 relating to a fourth modified example of the first embodiment. FIG. 16B is a cross-sectional diagram of the supporting member in the LED lamp 600 along line A-A′ shown in FIG. 16A. FIG. 16C is a cross-sectional diagram of the supporting member in the LED lamp 600 along line B-B′ shown in FIG. 16A. Configuration elements which are identical to in the first embodiment are labeled using the same reference signs in FIGS. 16A-16C, and explanation thereof is omitted.

The LED lamp 600 in present modified example differs from the LED lamp 100 in the first embodiment in terms of configuration of the light-transmitting substrate and the supporting member, and also in terms of method of fixing the light-transmitting substrate to the supporting member.

### 1. Configuration

The LED lamp 600 includes a light-transmitting substrate 602 having a through hole provided in a section of the light-transmitting substrate 602 other than a central section thereof. A head part 617 of a supporting member 611 has a protrusion 617e provided thereon. The light-transmitting substrate 602 is joined to an upper surface 617c of the head part 617 of the supporting member 611 using an engagement structure in the same way as in the LED lamp 500.

### 2. Effect

In the configuration described above, the through hole in the light-transmitting substrate 602 is provided in the section of the light-transmitting substrate 602 which is not the central section thereof. An effect of the above configuration is that elements on the light-transmitting substrate 602, such as a Zener diode and wiring, can be positioned centrally on the light-transmitting substrate 602. Consequently, a degree of freedom when designing the light-transmitting substrate 602 is increased. For example, the light-transmitting substrate 602 may be designed to be smaller in size or to have a greater number of LEDs 603a positioned thereon.

### Fifth Modified Example

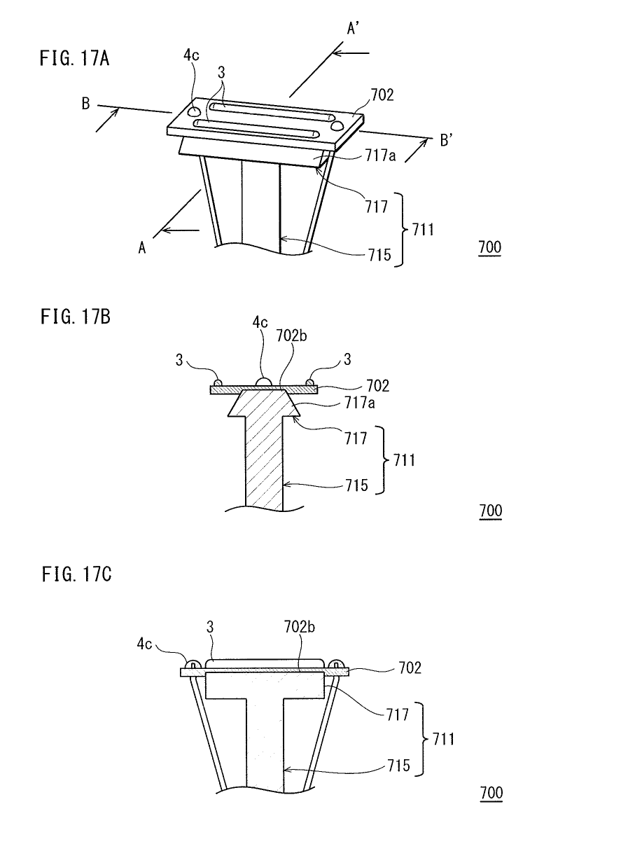

FIG. 17A is a perspective diagram showing structure of a supporting member in an LED lamp 700 relating to a fifth modified example of the first embodiment. FIG. 17B is a cross-sectional diagram of the supporting member in the LED lamp 700 along line A-A′ shown in FIG. 17A. FIG. 17C is a cross-sectional diagram of the supporting member in the LED lamp 700 along line B-B′ shown in FIG. 17A. Configuration elements which are identical to in the first embodiment are labeled using the same reference signs in FIGS. 17A-17C, and explanation thereof is omitted.

The LED lamp 700 in present modified example differs from the LED lamp 100 relating to the first embodiment in terms of configuration of the light-transmitting substrate and the supporting member.

### 1. Configuration

In the LED lamp 700, a light-transmitting substrate 702 has a recess 702b provided therein. The recess 702b in the light-transmitting substrate 702 corresponds to an upper section of a head part 717 of a supporting member 711 in terms of shape. The light-transmitting substrate 702 is joined to the supporting member 711 by insertion (fitting) of the upper section of the head part 717 into the recess 702b in the light-transmitting substrate 702. Once the upper section of the head part 717 is inserted into the recess 702b, adhesive is applied therebetween, thus fixing the light-transmitting substrate 702 to the supporting member 711.

### 2. Effect

An effect of the above configuration is that the light-transmitting substrate 702 is joined to the supporting member 711 over a large surface area, and therefore discharge of heat produced by the light-emitting units 3 can be increased. More specifically, discharge to the supporting member 711 of heat produced by the light-emitting units 3 can be further increased.

### Further Modified Examples

### (1) Light-Transmitting Substrate and Light-Emitting Unit

(1.1) Light-Transmitting Substrate

In the embodiments and modified examples described above, the light-transmitting substrate is a substrate having light-transmitting properties, and LEDs are mounted on only one side of the light-transmitting substrate. However, the present invention is not limited by the above. For example, even if a non light-transmitting substrate is substituted for the light-transmitting substrate, light can still be emitted in the downwards direction by mounting LEDs on both sides of the non light-transmitting substrate.

In the embodiments and modified examples described above, the light-transmitting substrate is either circular or rectangular in planar view. However, shape of the light-transmitting substrate in planar view is not limited by the above.

In the embodiments and modified examples described above, the light-transmitting substrate is a thin board (surface area of the side surface is small in proportion to surface area of the upper surface). Alternatively, the light-transmitting substrate may be a thick board or a block.

In the Description of the present invention, light-transmitting substrate refers to a substrate, regardless of shape, thickness and form, having a semiconductor light-emitting element (including both component types and surface mounted types) mounted thereon and a connection pattern for electrically connecting the semiconductor light-emitting element. Therefore, the substrate may alternatively be a block.

(1.2) Light-Emitting Unit

In the embodiments and modified examples described above, LED components are used for the LEDs, but the present invention is not limited by the above. For example, surface mount type LEDs or a bullet type LEDs may alternatively be used for the LEDs.

Furthermore, in the embodiments and modified examples described above, LEDs are used as the light-emitting element, but alternatively an LD, or an EL element (an organic or inorganic Electro-Luminescence element) may be used for the light-emitting element. Further alternatively, the light-emitting element may be realized by any combination of the above listed light-emitting elements.

In the embodiments and modified examples described above, LEDs are used that emit blue light and fluorescent particles are used that convert blue light to yellow light. Alternatively, a different combination of LEDs and fluorescent particles may be used. In one example of an alternative combination, when white light is to be emitted from the lamp, LEDs may be used that emit ultraviolet light, and three different types of fluorescent particles may be used that respectively convert ultraviolet light to red, green and blue light.

Further alternatively, when white light is to be emitted a combination of three different types of LED elements may be used that respectively emit red, green and blue light. Light emitted from the light-emitting unit is not limited to being white light, and therefore various different LEDs (including component type and surface mount type) and fluorescent particles may be used depending on the intended use of the lamp.

(1.3) Encapsulating Member

In the embodiments described above, each of the encapsulating members encapsulates a plurality of LEDs mounted on the light-transmitting substrate, but the present invention is not limited by the above. For example, each of the LEDs may be individually encapsulated by a different encapsulating member, or alternatively all of the LEDs may be encapsulated by the same encapsulating member.

In the embodiments and modified examples described above fluorescent particles are mixed into the encapsulating member, but alternatively a fluorescent layer including fluorescent particles may be provided on an inner surface of the globe. Further alternatively, a wavelength converting member such as a fluorescent board including fluorescent particles, which is separate from the encapsulating member, may be provided in a pathway of light emitted from the LEDs. High temperature of the fluorescent particles causes reduction in wavelength conversion efficiency thereof. Consequently, if the fluorescent particles are included in a fluorescent layer provided on the inner surface of the globe, the fluorescent particles are affected less by heat produced during LED light emission than if the fluorescent particles are included in the encapsulating member encapsulating the LEDs. Therefore, by including the fluorescent particles in the fluorescent layer, reduction in wavelength conversion efficiency of the fluorescent particles can be decreased.

In the embodiments and modified examples described above, two light-emitting units are mounted on the light-transmitting substrate, but alternatively just one light-emitting unit may be mounted on the light-transmitting substrate.

### (2) Globe

In the embodiments and modified examples described above, an A-type globe is used, but the present invention is not limited by the above. Alternatively, the globe may be an R, B or G type, or may be of a completely different shape to a bulb-shape of an incandescent light bulb, or a globe shape of a fluorescent LED lamp.

The globe may be transparent so that inside of the globe is visible, or alternatively the globe may be semi-transparent so that inside of the globe is not visible. The globe may be made semi-transparent by forming a scattering layer on the inner surface of the globe, the scattering layer for example having calcium carbonate, silica or a white pigment as a main constituent thereof. Alternatively, processing such as abrasive blasting may be performed to roughen the inner surface of the globe.

In the embodiments and modified examples described above, the globe is formed from a glass material, but alternatively the globe may be formed from a different material. For example, the globe may alternatively be formed from a resin or ceramic with light-transmitting properties.

### (3) Case

In the embodiments described above, the case is formed from a resin material, but alternatively the case may be formed from a different material. The case may alternatively be formed from a metal material, in which case insulation of the case from the base cap is necessary. Insulation of the case from the base cap may be ensured for example by applying an insulating layer on an outer circumferential surface of a narrow section of the case. Alternatively, insulation processing may be performed on the narrow section of the case. Further alternatively, insulation of the case from the base cap may be ensured by forming a section of the case closest to the globe using a metal material, forming a section of the case closest to the base cap from a resin material, and subsequently joining the two sections of the case.

### (4) Base Cap

In the embodiments and modified examples described above, an Edison-type base cap is used, but alternatively a base cap of a different type may be used such as a pin-type (specifically a G type such as GY or GX).

In the embodiments and modified examples described above, the base cap is attached (joined) to the case by threading the screw thread of the shell the screw-shaped section (narrow section) of the case. Alternatively, the base cap may be attached to the case using a different method. For example, the base cap may alternatively be attached to the case by caulking, forcible insertion, use of adhesive, or any combination of two or more of the above methods.

### (5) Stand Part

The stand part may alternatively have a different shape than described in the embodiments and modified examples above. For example, the stand part may alternatively be a polyhedron such as a cuboid.

### (6) Circuit Unit

In the embodiments and modified examples described above, the circuit unit only has a function of supplying power to the light-emitting unit, but alternatively a circuit for performing lighting control of the LEDs via a wireless signal or the like may also be provided in the circuit unit. Lighting control referred to above, includes for example starting lighting, suspending lighting, adjusting lighting (dimming) and changing lighting color.

### (7) Supporting Member

In the embodiments and modified examples described above, the leg part of the supporting member is cylindrical. In other words, a cross-section of the leg part taken perpendicular to a lamp axis is a circle. However, the above is not a limitation on the present invention. For example, the cross-section of the leg part may alternatively be a polygon such as a triangle or a square.

### (8) Installation in a Lighting Fixture

LED lamps described in the above embodiments are suitable for use in various lighting apparatuses. Installation of the LED lamp 100 relating to the first embodiment in a lighting fixture for down-lighting is explained below as one example of the above.

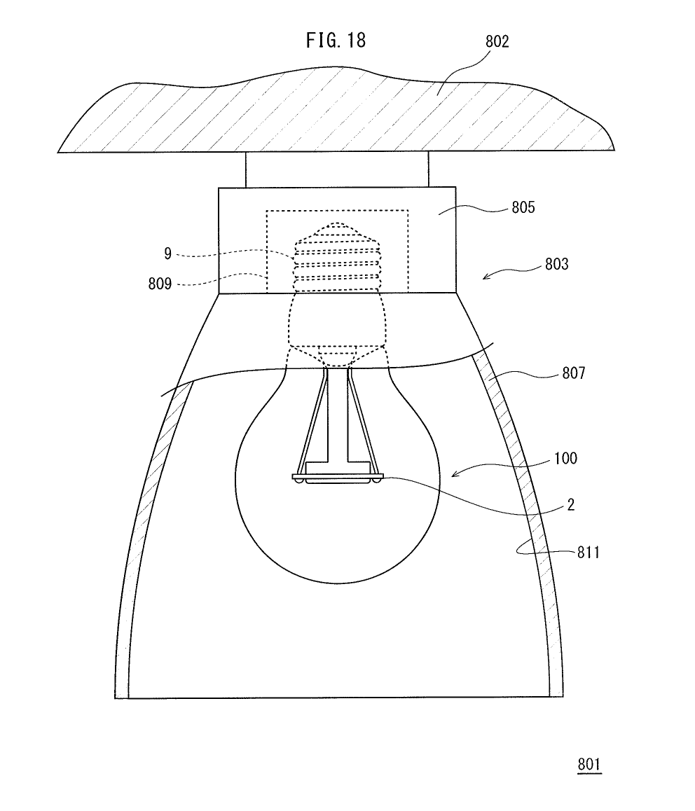

FIG. 18 shows an outline of a lighting apparatus 801.

The lighting apparatus 801 may be used for example while mounted on a ceiling 802 as shown in FIG. 18. The lighting apparatus 801 includes a lighting fixture 803 for installation of an LED lamp (for example the LED lamp 100 relating to the first embodiment) and causing lighting and suspension of lighting of the LED lamp.

The lighting fixture 803 may for example include a fixture body 805 that is attached to the ceiling 802 and a cover 807 that is attached to the fixture body 805 and that covers the LED lamp 100. The cover 807 is of an open-type having an opening at one end, and a light reflective film 811 provided on an inner surface of the cover 807 that reflects light emitted by the LED lamp 100 in a certain direction (downwards in the present example).

The fixture body 805 includes a socket 809 into which the base cap 9 of the LED lamp 100 is attached. The LED lamp 100 is supplied with power through the socket 809.

When the LED lamp 100 is installed in the lighting fixture 803, a position of the light-transmitting substrate 2 is approximately equivalent to a position of a filament of an incandescent light bulb when the incandescent light bulb is installed in the lighting fixture 803. Therefore, a center of light-emission of the LED lamp 100 is approximately equivalent to a center of light-emission of the incandescent light bulb.

As a consequence of the above, when the LED lamp 100 is installed in a lighting fixture intended for installation of an incandescent light bulb, a center of light-emission of does not change compared to when the incandescent light bulb is installed, and therefore occurrence of problems such as ring-shaped shadows forming on illuminated surfaces is prevented.

In the present embodiment the light-emitting unit 3 is housed in the globe 5, and the globe 5 is of approximately the same size as the incandescent light bulb. Therefore, the LED lamp 100 is similar to the incandescent light bulb in terms of overall shape. Consequently, in almost 100% of cases the LED lamp 100 is suitable for installation in conventional lighting fixtures intended for installation of the incandescent light bulb.

The lighting fixture described above is only one example of a lighting fixture. Alternatively, the lighting fixture may include a closed-type cover instead of an open-type cover like the cover 807. Further alternatively, the lighting fixture may be of a type where lighting of the LED lamp occurs while the LED lamp is installed in a sideways configuration (a configuration where a central axis of the LED lamp is horizontal) or an inclined configuration (a configuration where the central axis of the LED lamp is inclined relative to a central axis of the lighting fixture).

The lighting apparatus is a direct-mount type wherein the lighting fixture is mounted on a ceiling or wall in direct contact therewith. Alternatively, the lighting apparatus may be an embedded type wherein the lighting fixture is mounted into a ceiling or a wall, or a hanging type wherein the lighting fixture hangs from a ceiling and is connected thereto by an electrical cable.

In the above description the lighting fixture lights one LED lamp installed therein. Alternatively, the lighting fixture may light a plurality of LED lamps, for example three, installed therein.

Any of the LED lamps relating to the modified examples described above may alternatively be used as the LED lamp installed in the lighting apparatus described above.

### (9) Supplementary Explanation

In the embodiments and modified examples described above, the stand part and the supporting member are configured by a single element, but the present invention is not limited by the above. For example, the stand part and the supporting member may alternatively be configured as separate elements, and then subsequently be fixed to one another using a fitted structure, engagement structure or the like.

### INDUSTRIAL APPLICABILITY

A lamp relating to present invention is appropriate for use as a bulb-type LED lamp as an alternative to an incandescent light bulb.

### REFERENCE SIGNS LIST

2 light-transmitting substrate
3 light-emitting unit
3a LEDs
3b encapsulating member
11 supporting member
13 stand part
15 leg part
17 head part
100 LED lamp

1. A lamp, comprising:
a base;
a supporting member including a leg part that is rod-shaped and disposed upright on the base, and a head part that is positioned on top of the leg part and that has an upper surface and a side surface that is a continuation of the upper surface;
a light-transmitting substrate mounted on the upper surface of the head part; and
at least one light-emitting unit mounted on the light-transmitting substrate, wherein
in planar view of the lamp in a downwards direction, the light-emitting unit is positioned at least partially on a section of the light-transmitting substrate that extends beyond the upper surface of the head part,
at least one section of the side surface of the head part is an inclined section that is inclined relative to the upper surface of the head part and that forms an obtuse dihedral angle therebetween, and
the inclined section of the side surface of the head part is light reflective.

2. The lamp in claim 1, wherein
the light-emitting unit is plural in number,
the light-emitting units each have an elongated shape and are positioned parallel to one another, in terms of a longitudinal direction thereof, on the light-transmitting substrate,
the head part of the supporting member has four side faces that form the side surface of the head part,
two side faces among the four side faces are the inclined section of the side surface of the head part, and
the two side faces that are the inclined section of the side surface of the head part are in opposing positions to one another and are parallel to the longitudinal direction of the light-emitting units.

3. The lamp in claim 1, wherein
surface roughness of the inclined section of the side surface of the head part, is greater than surface roughness of a non-inclined section of the side surface of the head part, or is greater than surface roughness of the upper surface and a lower surface of the head part.

4. The lamp in claim 1, wherein
the supporting member further includes a stand part, positioned between the leg part of the supporting member and the base,
at least one section of a side surface of the stand part is an inclined section that is inclined relative to the upper surface of the head part and that forms an obtuse dihedral angle therebetween, and
the inclined section of the side surface of the stand part is light reflective.

5. The lamp in claim 1, wherein
the light-transmitting substrate is a circular disc, and
the head part of the supporting member is a truncated cone.

6. The lamp in claim 1, wherein
a recess is provided in the light-transmitting substrate, and
at least an upper section of the head part of the supporting member is fitted into the recess in the light-transmitting substrate.

7. The lamp in claim 1, wherein
a recess is provided in a surface of the light-transmitting substrate that is mounted on the upper surface of the head part,
a protrusion is provided on the upper surface of the head part, and
the protrusion on the upper surface of the head part is fitted into the recess in the light-transmitting substrate.

8. The lamp in claim 7, wherein
an element or a wire is provided in a central section of the light-transmitting substrate, and
the recess is provided in a section of the light-transmitting substrate other than the central section.

9. A lighting apparatus provided with the lamp in claim 1.
